(19) United States
(12) Patent Application Publication
(10) Pub. No.: US 2003/0101310 A1
(43) Pub. Date: May 29, 2003

(54) Using a PC for testing devices

(76) Inventors: Jack L. Granato, Safety Harbor, FL (US); Kenneth L. Martin, St. Petersburg, FL (US)

Correspondence Address: Honeywell International Inc., Law Dept. AB2, PO Box 2245, Morristown, NJ, 07962-9806, US

(21) Appl. No.: 10/007,004

(22) Filed: Nov. 29, 2001

(51) Int. Cl. G06F 13/36

(52) U.S. Cl. 710/306

(57) ABSTRACT

A system is disclosed that uses a personal computer and related applications for providing operating instructions in receiving data from devices connected to any non PCI standard bus. The system uses an intermediate signal processor that communicates with the gate array and is programmed to respond to the signal processor and bus control logic units for the non PCI standard bus for each device.

### BACKGROUND

This invention relates to the use of a standard personal computer (PC) as a host computer to perform real-time testing of a plurality of devices on a bus.

The versatility of PCs and application programs makes the PC ideal for testing devices. But typically, devices are connected to a bus that is not necessarily compatible with the typical PC PCI bus. For example, one type of common bus protocol for military applications is the military standard 1553 bus (MIL-STD-1553). Different devices can be connected to this bus, which provides a standard signal and data interface communication standard. An inertial reference unit (IRU) is a system consisting of accelerometers and rotational sensing devices such as rotating gyros, ring laser gyros or fiber-optic gyros that are designed to operate on that bus and must be tested using it. But the 1553 bus' special characteristics and operating limits create complexities in designing and operating a high speed connection with a PCI bus on a personal computer, especially if the goal is connecting many devices, each connected to a bus to one PC for coordinated high speed operational testing, even with the PC at a remote location.

### SUMMARY

A requirement that the PC have the capability of operating directly with the device bus interrupts can produce PC operating system overheads when servicing real-time interrupts, degrading system performance. Host computer standard interfaces (e.g. the PC standard) are generally too slow to support real-time command and control of data buffering with the device bus (e.g. the 1553 bus). The resulting potential bottleneck is avoided, as explained below, through the use of an intermediate signal processor and a gate array 26, both specially programmed to work with the PC processor and the device bus (e.g. a 1553 bus) using a shared-memory architecture. The signal processor is selected to have enough capacity (throughput) to handle the data flow of a plurality (e.g. four or more) devices “simultaneously” and make “real-time decisions”. This can be essential in test applications requiring synchronization, for example incrementing each IRU fixture through different positions when testing IRUs, a process involving reading the data from the IRU over the 1553 bus and position data from the fixture.

The signal processor and the programmed gate array 26 provide a real-time connection between the device and the PC user that is capable of accessing data through a shared memory. The PC's processor can perform simple reads and writes to the shared memory to move data for processing and perform data processing functions independent of the speed of the input and output of bus.

### BRIEF DESCRIPTION OF THE DRAWING

FIG. 1 is a functional block diagram showing a system employing the invention.

FIG. 2 to is a flow chart showing the signal processing steps for controlling a bus according to the invention.

FIG. 3 is a flow chart illustrating the operation of a gate array 26 according to the invention.

### DESCRIPTION

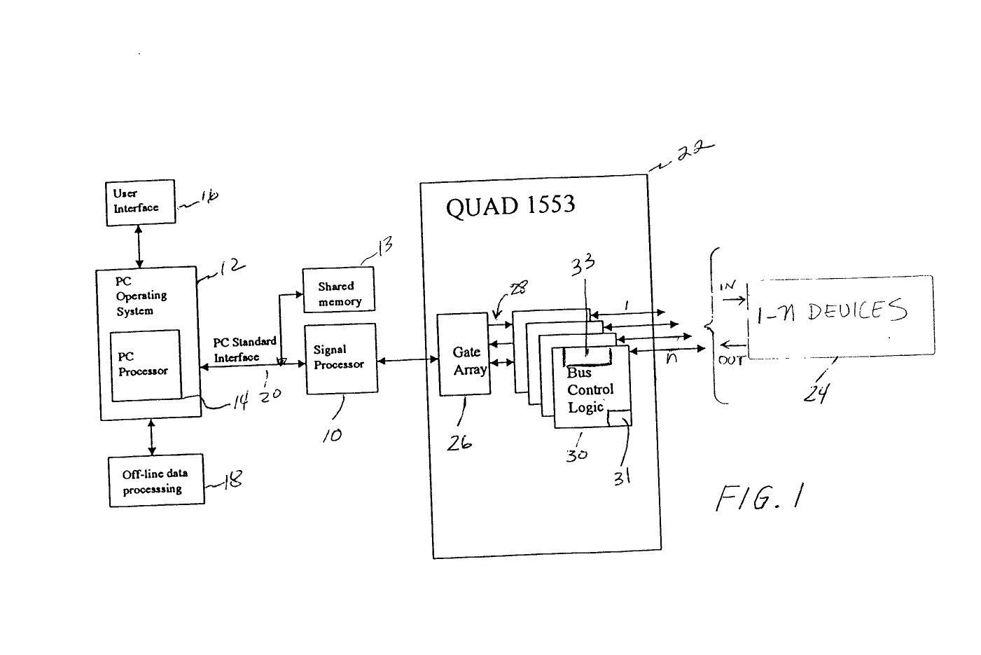

Referring to FIG. 1, a signal processor 10 communicates with a PC 12, which contains a PC processor 14. The PC 12 is connected to a user interface 16, such as a display and keyboard and also is used to perform off-line data processing 18. A PC standard interface (PCI) 20 connects the PC operating system 12 through the PC processor to the signal processor 10. The signal processor 10 connects to another bus 22 with operating protocols and standards that are different than those for the PCI bus 20. In this example, the bus 22 is assumed to conform to the 1553 standard and comprises 1-n channels coupled to 1-n devices 24 each with an input (in) and output (out). Each device may be an IRU, for example. The bus 22 includes a gate array 26 that connects over address, data and control buses 28 with n bus control logic units 30, one for each device 24. A shared memory 13 is connected to the PCI bus 20 for use by the signal processor 10 and the PC processor 14. The system shown in FIG. 1 uses the PC processor 14 to perform off-line processing using a local application program, enabling a PC user to cooperate with each device 24, notwithstanding the fact that each device 24 is programmed to receive and produce data by the protocol of the bus 22.

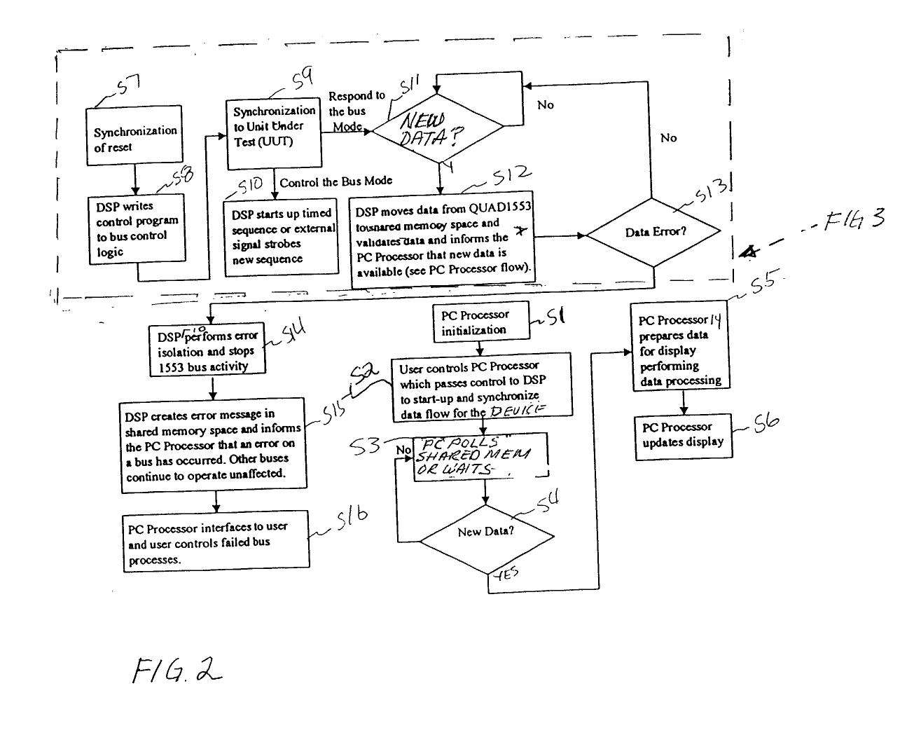

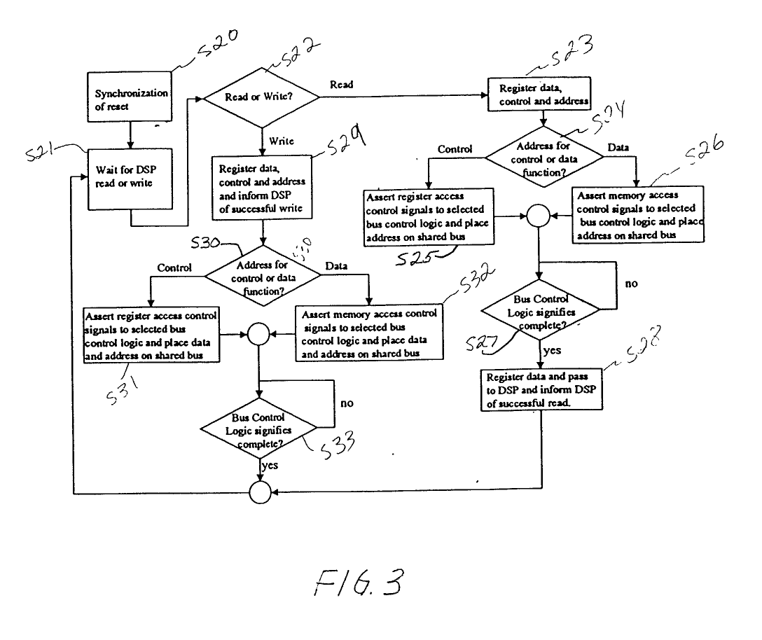

FIG. 2 illustrates the processing flow for the system and several concurrent processes that operate simultaneously, and FIG. 3 expands on the steps shown by the dotted-line box identified as such in FIG. 2. In step S1, the PC processor 14 initializes following a normal initialization process, and in step S2 the user controls the PC processor 14 by entering appropriate commands to cause the PC processor 14 to pass control to the signal processor 10 to start up and synchronize data flow to the devices 24 using the gate array 26 and each of the individual bus control logic units 30. The process then moves to step S3, where the PC processor 14 polls the shared memory 13 or waits for an interrupt from the signal processor 10. In this manner, the PC processor 14 knows that there is “content” in the shared memory 13. As explained subsequently, the shared memory 13 may contain all the data from the devices 24. In the next step, S4, a query is made to determine whether there is new data in the shared memory 13, and a negative answer prompts a return to step S3, but a positive answer moves the sequence to step S5, where the PC processor 14 prepares any data for display at step S6 for the user application running on the PC processor 14 by performing off-line processing 18, i.e. a specific program for manipulating and displaying the operating characteristics of the devices 24. The data thereby appears on the user interface 16 in a way that is useful and convenient for the user. Up to this point, the process has centered on how data is removed from the devices 24 through the bus 22 and the gate array 26 and displayed on the user interface 16. Data is moved between the devices 24 and the signal processor 10 over the bus 22 beginning at step S7, synchronizing the signal processor 10 and bus 22. Then in step S8, the signal processor 10 writes the appropriate control programs for the devices 24 into a memory 33 on each bus control logic unit 30. In step S9, two modes are controlled by the signal processor 10 for each bus control logic unit 30; one mode is to respond to the bus; the other mode is to control the bus. Only one of those control modes are produced at a time during a processing cycle through the steps. Any bus control logic unit 30 operates independently to drive the respective device 24, in bus control mode, or to respond to the bus (in respond to the bus mode), while the gate array 26 supports data and control updates to the bus control logic 30. At step S10, the signal processor 10 starts up timed sequences and the bus control logic unit 30 controls the flow of data between a device 24 and the signal processor 10, which is “waiting” for the data. On the other hand, step S11 begins a sequence where the devices 24 control the flow of data between the bus control logic units 30 and the signal processor 10. Thus, in step S11, the bus control logic 30 performs a test to determine if there is new data to receive from the devices 24. A positive answer moves to step S12, where the signal processor 10 moves the data from the bus to the shared memory 13, validates the data and informs the PC processor 14 that new data is available. The new data is retrieved when step S4 is called. A negative answer at step S13 means that the data is valid and the process simply waits for additional data. If, however, there is an error, which produces an affirmative answer in step S13, the process moves to step S14 where the signal processor identifies the defective bus and terminates the operation of the sequence for just that bus. A defect may be caused by a device 24, its connection, or its respective bus control logic unit 30. The device 24 that is connected to the faulty bus will not provide data to the PC operating system 12 when this happens. In step S15, the signal processor 10 creates an error message for the defective bus in the shared memory 13 and informs the PC processor 14. Meanwhile, the other bus control logic units 30 and their respective bus connections are unaffected. Step S16 notifies the user about the presence of a defective bus. An option is to have the identity of the defective bus 30 and device, displayed on the user interface 16, something done by suitably programming the PC's application program.

This sequence frees the PC processor 14 to perform off-line processing and allows the user to interface to the system through a standard operating system because several concurrent processes operate after initialization. The user communicates with the PC Processor 14, which starts the signal processor 10 and processes for the bus 22 which after being initialized communicates on the bus without processor interaction except for when the signal processor 10 is interrupted for pre-timed events when controlling the bus and for messages received when configured to not control but respond to commands on the bus 22. Upon an interrupt, the signal processor 10 moves the data from shared memory local to the bus into memory shared with the PC Processor. The PC processor performs calculations and formats the data performing offline processing 18, to display the results of bus activity to the user.

The gate array 26 acts as a slave to the digital signal processor in this process, waiting for the signal processor to perform a read or a write. If a write is being performed, the gate array 26 registers the address, control and data and then releases the signal processor 10 by informing that the write is complete by issuing an acknowledge signal. The gate array 26 decodes the write request and compares the address passed to its' internal memory map and determines if the signal processor 10 is trying to communicate to registers inside the bus control logic or if the signal processor 10 is trying to write to the shared memory 13 between the bus control logic 30 and the gate array 26. The gate array 26 issues different control signals based on whether the access is for a control function (writes to internal registers 31 on the bus control logic 30) or a data function (writes to shared memory 33 in the bus control logic). The gate array 26 then waits for the bus control logic 30 to signify that the write has been completed, by asserting an acknowledge to the gate array 26. The gate array 26 then can accept a new command from the signal processor 10. If the signal processor 10 issues a new request before the gate array 26 is ready to accept one, the gate array 26 ignores the request and the signal processor 10 waits for the gate array 26.

If a read is being performed, the gate array 26 registers the address, control and data. The gate array 26 decodes the read request. Then it determines if the signal processor 10 is trying to communicate with registers 31 (inside the bus control logic) or if the signal processor 10 is trying to read the shared memory 13. The gate array 26 issues different control signals based on whether the access is for a control function (reads registers internal to bus control logic) or a data function (reads shared memory through the bus control logic units 30. The gate array 26 then waits for the bus control logic to signify that the read has been completed, by asserting an acknowledge to the gate array 26. The gate array 26 then registers the data from the bus control logic, passes the data to the signal processor and then releases the signal processor by informing that the read is complete by issuing an acknowledge control signal. The gate array 26 then can accept a new command from the signal processor. For reads the signal processor cannot issue a new request before the gate array 26 is ready to accept one since it must wait for the gate array 26 to acknowledge that the operation is complete.

FIG. 3 shows the flow diagram for the operation of the gate array 26 which controls the flow of data between the bus control logic units 30 and the signal processor 10 to accomplish the data transfer previously described. Step S20 synchronizes the gate array 26 with signal processor 10. In step S21, the gate array 26 waits for instructions from the signal processor 10, and when an instruction is received, step S22 is called, where a decision is made as to whether the signal processor 10 is going receive data via the gate array 26 or write data via the gate array 26 from the control logic units 30. In the read state, step S23 is called, causing the gate array 26 to capture data for the read a bus control logic memory 33. It is important to understand that at step S23, the signal processor 10 is waiting while the gate array 26 performs the subsequent steps, beginning with step S24. At that point the gate array 26 performs a test that determines if the information that will be read by the signal processor is a control parameter or a data parameter. Assuming a control parameter instruction is produced, step S25 will access registers 31 in bus control logic units 30. If the test made in step S24 shows that data is expected, the gate array 26 accesses the memory 33 sequentially, one bus control logic unit 30 at a time, thus receiving data from each device 24 stored in the bus control logic memory 33. At step S27, the gate array 26 waits until the bus control logic unit 30 indicates that data determined from steps S25 and S26 are available. An affirmative answer calls step S28, at which time the control and data, that is the data from the registers and the memory on the bus control logic units 30 are passed to the signal processor from the gate array 26. From step S28, where the data is provided to the signal processor 10 with an acknowledge to signal that the processor application could use the data beginning with step S12 in FIG. 2.

Returning however to step S22, if the gate array 26 instruction is to write data (from the signal processor 10 to the gate array 26 which then transfers the data to the respective bus control logic 30), the processes begin at step S29 where the gate array 26 first captures all of the register data and control and address information from the signal processor, and signifies a successful “write”. Step S29 completes a successful data write to the signal processor 10, allowing it to return to processing that data starting as step S12 (see FIG. 2). Then the process moves to step S30. Here, like step S24, the gate array 26 performs a test to determine the instruction is to control data or for just data. At step S31, control data is written to the register in each bus control logic unit 30. The gate array 26 at this point makes a decision and writes the control data one at a time to the respective register 31 on a bus control logic unit 30, i.e. for a specific device 24. If the test in step S30 determines that the instruction from the signal processor 10 is for data, the process calls step S32, where the gate array 26 writes data individually to the memory 33 on the respective bus control logic unit 30. The gate array 26 waits, step S33, until it receives an affirmative answer from the bus control logic unit 30 to which the control information or data is written. This takes place sequentially for each bus control logic unit and its respective device. Then the gate array 26 returns to step S22, waiting for more instructions from the signal processor 10 as to whether data will read or written.

One skilled in the art may make modifications, in whole or in part, to a described embodiment of the invention and its various functions and components without departing from the true scope and spirit of the invention.

1. A system for controlling a plurality of devices, comprising:
a first computer comprising a first bus, a first signal processor and a user interface for entering instructions and running an application program to receive data from each device, provide instructions to each device and analyze the operation of each device, said first bus operating at a first rate;
a second bus that operates had a second array different from said first rate;
a bus control logic unit controlling data flow by each device to the second bus;
a second signal processor connected to read from and write data to the first bus;
a gate array responsive to signals from said second signal processor for reading from and writing data to the second signal processor and each bus control logic unit to control the operation of each device in response to instructions generated from said first computer; and
a memory for storing data while either the first signal processor or the second signal processor is performing operations on previous data in said memory.

2. The system described in claim 1, wherein:
each bus control logic unit comprises means for storing data for its respective device from said gate array while said second signal processor is unavailable for utilizing said data.

3. The system described in claim 1, wherein:
said gate array waits for a bus control logic unit to signify that data has been completely read from or to the gate array and the second signal processor waits for said acknowledgement before providing data to or receiving data from said gate array.

4. The system described in claim 3, wherein:
said second signal processor stores data from said gate array in said memory for use by said first signal processor.

5. The system described in claim 1, wherein:
each bus control logic unit comprises means for storing data control instructions from said gate array for its respective device while said second signal processor is unavailable for utilizing said data.

6. The system described in claim 1, wherein:
said bus control logic unit provides a signal to say gate array to cause said first computer to identify than a bus connection with a device is defective.

7. A method for controlling a plurality of devices, comprising:
running an application program on a first computer;
using a first data bus on said first computer for exchanging data between said first computer and a signal processor;
storing said data in a memory on said first bus for subsequent use by said signal processor;
exchanging data between said signal processor and a gate array;
exchanging gate array produced data with logic units, each controlling the exchange of data between a respective device and a bus that operates as a different rate and different protocols then the first data bus; and
storing data produced by the devices with said logic devices until the gate array is available to use said data.

8. The method described in claim 7, further comprising generating a signal from one of the logic units to indicate that a bus connection to its respective device is defective.

9. A system for controlling devices comprising:
first means for running an application program for a user interface to control the operation of the devices and manipulate data manifesting the operation of the devices;
a first data bus for exchanging data between said first means and a signal processor;
means connected to said first data bus for storing said data for subsequent use by said signal processor;
a local bus that connects the devices;
a gate array for exchanging data between said signal processor and the devices;
means associated with each device for controlling the exchange of data between said gate array and a device over said local bus and storing data for use by said gate array.

10. The system described in claim 9, wherein:
said means associated with each device comprises means for generating a signal that manifests that defective communication between the device and the local bus.

11. A method for controlling devices, comprising:
running an application program for a user interface to control the operation of the devices and manipulate data manifesting the operation of the devices;
exchanging data between said first means and a first signal processor on a first data bus for;
storing said first data for subsequent use by said first signal processor;
connecting the devices over a local bus;
exchanging data between said signal processor and the devices using a second signal processor; and
controlling the exchange of data between said second signal processor and each device over said local bus and storing data on said local bus for use by said second signal processor.

12. The method described in claim 11, wherein the second signal processor comprises a gate array.
